(19) United States
(12) Patent Application Publication
(10) Pub. No.: US 2010/0191390 A1
(43) Pub. Date: Jul. 29, 2010

(54) SYSTEM AND METHOD FOR DETECTING THE OCCUPANCY OF A VEHICLE SEAT

(75) Inventors: Douglas R. Champion, Kokomo, IN (US); Mark A. Ginter, Russiaville, IN (US); Chance L. Scales, Kokomo, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/616,837

(22) Filed: Nov. 12, 2009

Related U.S. Application Data
(60) Provisional application No. 61/147,823, filed on Jan. 28, 2009.

(51) Int. Cl. G06F 7/00

(52) U.S. Cl. 701/1

(57) ABSTRACT

A passenger occupancy detection system and method are provided for detecting occupancy of a vehicle seat. The system includes a pressure sensor for monitoring pressure of the seat. Routines are employed to monitor the pressure and to determine the occupancy of the seat based upon one or more of vehicle acceleration, vehicle deceleration and variances in inertia experienced during driving of the vehicle. A supervisory routine may combine outputs from the multiple routines to process the outputs and provide an output indicative of a detected occupancy of the seat.

### CROSS-REFERENCE TO RELATED APPLICATION

This application claims priority under 35 U.S.C. §119(e) to U.S. Provisional Patent Application No. 61/147,823, filed on Jan. 28, 2009, the entire disclosure of which is hereby incorporated herein by reference.

### TECHNICAL FIELD

The present invention generally relates to passenger occupancy detection systems (PODS), and more particularly, relates to detecting the presence or absence of an occupant in a vehicle seat.

### BACKGROUND OF THE INVENTION

Passenger occupancy detection systems (PODS) are commonly employed on board vehicles to detect the presence of an occupant seated in a passenger seat of the vehicle. Passenger occupancy detection is employed to control vehicle devices. For example, passenger occupancy detection may be employed to activate or deactivate air bags, seatbelt pretensioners and other devices on board the vehicle.

Passenger occupancy detection systems typically employ a pressure sensitive fluid bladder located proximate to the vehicle seat and a pressure sensor for sensing pressure on the fluid bladder. The amount of pressure sensed by the pressure sensor is used as an indication as to whether or not an occupant is seated in the vehicle seat. Some passenger occupancy detection systems have the ability to self-calibrate when the vehicle seat is empty. The effects of both positive and negative offset errors present due to seat trim, seat foam and other seat features may be compensated for by a self-calibration. Some proposed methods rely on the use of an accelerometer to help with the self-calibration. However, the accelerometer generally is expensive and complicates the passenger occupancy detection system.

It is therefore desirable to provide for a passenger occupancy detection system that allows for detection of an occupant in a vehicle seat and provides cost-effective and easy self-calibration of the detection system.

### SUMMARY OF THE INVENTION

In accordance with one aspect of the present invention, a passenger occupancy detection system is provided for detecting occupancy of a vehicle seat. The system includes a pressure sensor operatively associated with a passenger seat in a vehicle for sensing pressure applied to the vehicle seat. The system also includes a controller for determining occupancy of the vehicle seat. The controller comprises first logic for monitoring the sensed pressure and determining a change in pressure as the vehicle is driven. The first logic compares the change in pressure to a first threshold to generate a first output. The controller also comprises second logic for monitoring the sensed pressure and determining a change in pressure during at least one of an acceleration of the vehicle and a deceleration of the vehicle, and generating a second output based on the sensed pressure during the at least one of the acceleration and deceleration of the vehicle. The controller further comprises a third logic for processing the first and second outputs to generate a third output indicative of occupancy of the seat.

According to another aspect of the present invention, a method for determining occupancy of a vehicle seat is provided. The method includes the steps of sensing pressure applied to a passenger seat in a vehicle, monitoring the sensed pressure as the vehicle is driven, determining a change in sensed pressure as the vehicle is driven, and comparing the change in pressure to a first threshold to generate a first output indicative of expected occupancy of the seat. The method also includes the steps of monitoring the sensed pressure during at least one of an acceleration of the vehicle and a deceleration of the vehicle, determining a change in pressure during the at least one of the acceleration of the vehicle and deceleration of the vehicle, and generating a second output based on the sensed pressure during the at least one of the acceleration and deceleration of the vehicle. The method further comprises the step of processing the first and second outputs to generate a third output indicative of occupancy of the seat.

According to another aspect of the present invention, a passenger occupancy detection system is provided for detecting occupancy of a vehicle seat. The system includes a pressure sensor operatively associated with a passenger seat in a vehicle for detecting pressure on the seat, and vehicle dynamics inputs for determining at least one of acceleration and deceleration of the vehicle. The system also includes a controller for detecting occupancy of the seat. The controller processes the vehicle dynamics inputs and determines at least one of acceleration and deceleration of the vehicle and measures pressure during at least one of acceleration and deceleration of the vehicle and without the at least one of the acceleration and deceleration of the vehicle and determines a change in pressure. The controller further determines occupancy of the seat based on the change in the sensed pressure.

According to a yet another aspect of the present invention, a method for determining occupancy of a vehicle seat is provided. The method includes the steps of sensing pressure applied to a passenger seat in a vehicle, determining at least one of acceleration and deceleration of the vehicle, and measuring pressure during at least one of the acceleration and deceleration of the vehicle and without the at least one of the acceleration and deceleration of the vehicle. The method further includes the steps of determining a change of pressure sensed during the at least one of acceleration and deceleration of the vehicle and pressure sensed without the at least one of acceleration and deceleration of the vehicle, and determining occupancy of the seat based on the change in sensed pressure.

According to a further aspect of the present invention, a passenger occupancy detection system is provided for detecting occupancy of a vehicle seat. The system includes a pressure sensor operatively associated with a passenger seat in a vehicle for sensing pressure on a seat. The system also includes a controller for sampling the sensed pressure during operation of the vehicle and detecting change in pressure values. The controller further determines a change in sensed pressure and compares the change in pressure to a threshold to determine occupancy of the seat.

According to yet a further aspect of the present invention, a method for determining occupancy of a vehicle seat is provided. The method includes the steps of sensing pressure on a passenger seat in a vehicle during operation of the vehicle, sampling the sensed pressure during operation of the vehicle, and processing the sampled pressures based on amplitude. The method further includes the steps of detecting a change in pressure values as the vehicle is driven, comparing the change in pressure values to a threshold, and determining occupancy of the seat based on the change in pressure values compares to the threshold.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a schematic top view of a vehicle employing a passenger occupancy detection system for detecting occupancy of a vehicle seat, according to one embodiment;

FIG. 2 is a block diagram illustrating the passenger occupancy detection system, according to one embodiment;

FIG. 3 is a block/flow diagram illustrating a supervisory routine for detecting occupancy of the vehicle seat;

FIG. 4 is a flow diagram illustrating an initiation routine for setting up the algorithms, according to one embodiment;

FIG. 5 is a graph illustrating pressure sensing during vehicle acceleration for use by the acceleration routine;

FIGS. 6A-6C illustrate a routine for detecting occupancy of a vehicle seat based on vehicle acceleration, according to one embodiment;

FIG. 7 is a graph illustrating the sensing of pressure during vehicle deceleration for a deceleration routine;

FIGS. 8A-8C illustrate a routine for detecting occupancy of a vehicle seat during vehicle deceleration, according to one embodiment;

FIG. 9 is a graph illustrating sensed pressure change during vehicle operation for detecting occupancy of a vehicle seat based on a variance algorithm; and

FIGS. 10A-10D illustrate a variance routine for detecting occupancy of a vehicle seat during operation of the vehicle, according to one embodiment.

### DESCRIPTION OF THE PREFERRED EMBODIMENTS

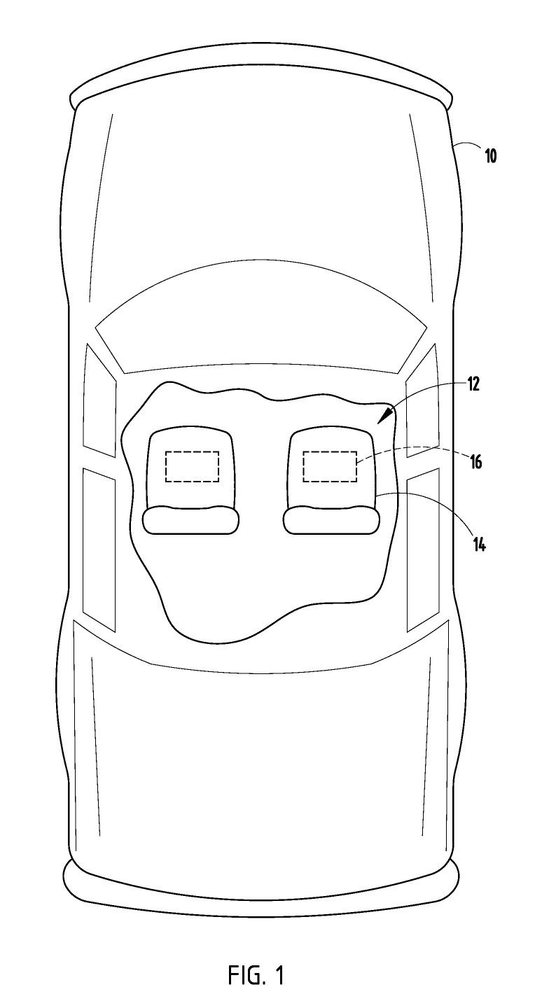

Referring to FIG. 1, an automotive vehicle 10 is generally illustrated having passenger seats 14 located in the passenger compartment for seating passengers. The vehicle 10 includes a passenger occupancy detection system 12 for detecting occupancy of the vehicle seat 14. The system 12 detects whether or not a passenger is located in the vehicle seat 14. This enables the vehicle 10 to deploy certain systems, such as air bag systems, seatbelt pretensioners, and other devices based on whether or not a passenger is determined to be located within a particular seat 14. It should be appreciated that the vehicle 10 may include an automotive vehicle having road wheels, according to one embodiment, or may include other vehicles having one or more seats for seating one or more passengers.

The passenger occupancy detection system 12 includes a fluid bladder 16 located in each seat 14 for which occupancy is to be determined. The fluid bladder 16 is pressure sensitive and realizes a pressure based upon the amount of force applied thereto, such as the force applied by a passenger seated in the vehicle seat 14. The fluid bladder 16 may include fluid, such as silicone or other known fluid. The fluid bladder 16 works in conjunction with a pressure sensor which senses the pressure of the bladder 16 and generates a sensed pressure output signal for use in the passenger occupancy detection system 12 as described herein. The pressure sensor outputs a voltage signal indicative of the sensed pressure, according to one embodiment.

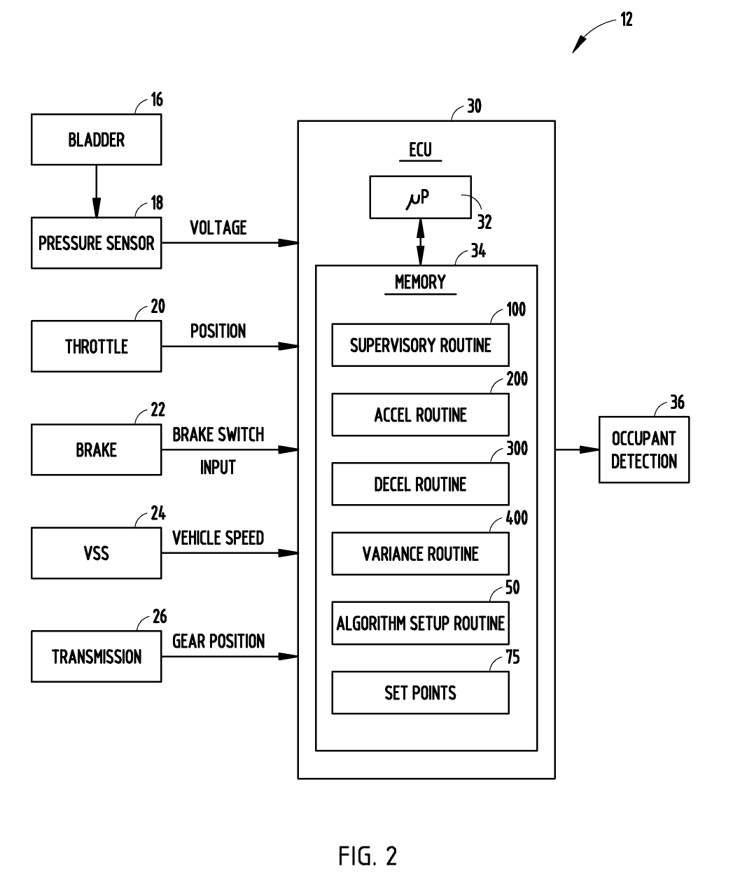

The passenger occupancy detection system 12 is shown in more detail in FIG. 2 having an electronic control unit (ECU) 30 for receiving various inputs, processing certain routines and generating an occupant detection output 36. The occupant detection output 36 may be employed by any of a number of devices or systems as is generally known for use on a vehicle. As shown, a pressure sensor 18 senses a pressure of the fluid bladder 16 and generates a voltage output indicative of the sensed pressure and inputs the voltage to the ECU 30. Additionally, ECU 30 receives a throttle position signal from the vehicle throttle 20, a brake switch input signal from vehicle brake 22, a vehicle speed signal indicative of the vehicle speed from the vehicle speed sensor (VSS) 24, and a gear position signal (e.g., PRNDL) from the vehicle transmission 26.

The ECU 30 is shown having control circuitry in the form of a microprocessor 32 and memory 34. Memory 34 may include random access memory (RAM), read-only memory (ROM), electrically erasable programmable read-only memory (EEPROM), flash memory or other known memory storage medium. It should be appreciated that the control circuitry, such as microprocessor 32 and memory 34, may store and execute routines as described herein according to various embodiments. Stored within memory 34 are various routines including algorithm setup routine 50, supervisory routine 100, acceleration routine 200, deceleration routine 300, and variance routine 400. Additionally, set points 75 are also shown stored within memory 34. The set points 75 may include various thresholds such as empty threshold Eₜ and weighted threshold Wₜ that are stored in memory for use by the routines to determine whether or not an occupant occupies a vehicle seat.

The passenger occupancy detection system 12 employs the variance routine 400 which distinguishes an empty seat (i.e., not occupied) from a weighted seat (i.e., occupied) based on the concept that larger objects exhibit more inertia with a road stimulus on the vehicle 10. The acceleration algorithm 200 exploits a condition where an object in the seat is driven into the seat upon acceleration of the vehicle 10. The acceleration routine 200 essentially looks for spikes in pressure during vehicle acceleration. The deceleration routine 300 exploits the alternate condition where an object in the seat is momentarily weightless or of a reduced rate in the seat upon deceleration of the vehicle 10. Each of the variance routine 400, acceleration routine 200 and deceleration routine 300 generates an output indicative of whether an occupant is seated within the vehicle seat of interest. Additionally, the supervisory routine 100 combines each of the variance routine 400, acceleration routine 200, deceleration routine 300 by processing the output flags generated by routines 200, 300 and 400 to further refine the determination of whether or not an occupant is seated within the vehicle seat.

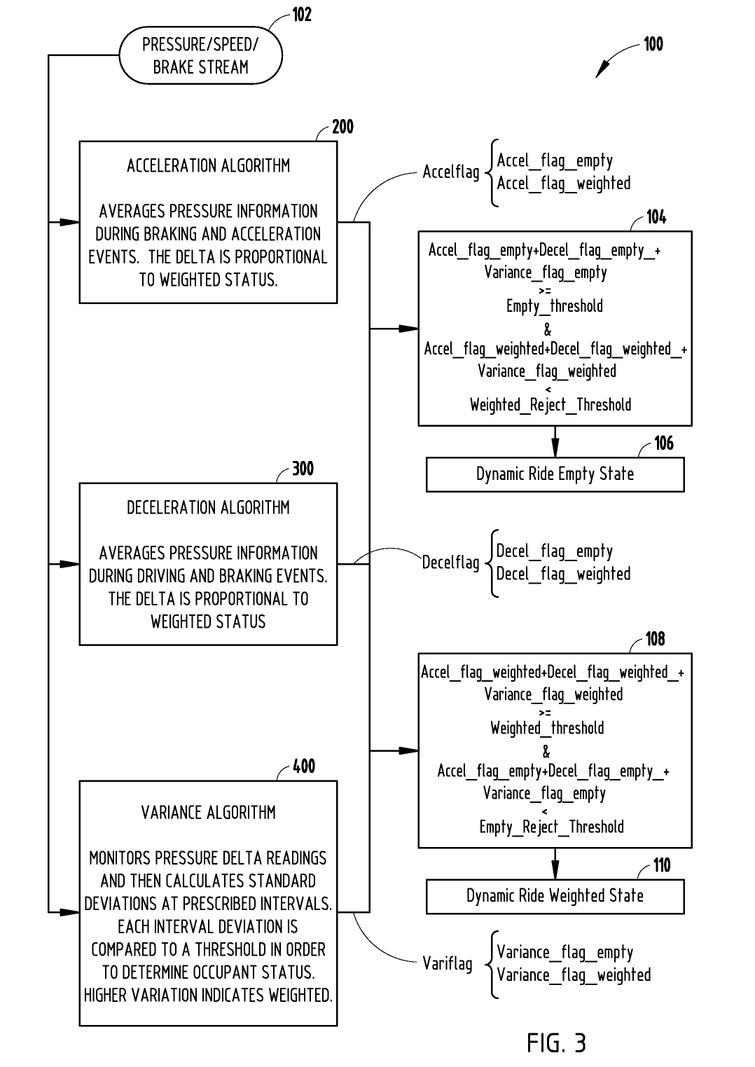

The supervisory routine 100 is generally shown in FIG. 3 combining each of the acceleration routine 200, deceleration routine 300, and variance routine 400. As shown, each of the routines 200, 300 and 400 receives the pressure, speed, brake stream and other information at step 102, processes the information pursuant to each routine with one or more algorithms, and each routine 200, 300 and 400 generates an output flag indicative of whether or not the corresponding routine has determined that an occupant (e.g., person) occupies a particular seat. The flags include an accelflag generated by the acceleration routine 200 which indicates an empty seat detected by accel_flag_empty or a weighted seat detected by accel_flag_weighted. Similarly, the deceleration routine 300 generates an output decelflag which indicates an empty seat by decel_flag_empty or a weighted seat detected by decal_flag_weighted. Finally, the variance routine 400 generates an output variflag which indicates an empty seat by variance_flag_empty or a weighted seat detected by variance_flag_weighted.

The accelflag, decelflag and variflag are individually applied as inputs to logic block 104 and logic block 108. The logic blocks 104 and 108 essentially provides a dynamic ride algorithm that generates a system empty or weighted detect output based on processing the state of each of accelflag, decelflag and variflag. The processing may be flexible, depending on different vehicles, different seats, etc. The dynamic ride logic 104 is shown summing up the empty seat states from the accelflag, decelflag and variflag and comparing the sum total to an empty threshold to see if the sum total exceeds the empty threshold. Logic 104 also sums the weighted states of each of the accelflag, decelflag and variflag and compares the sum total to a weighted reject threshold. If the sum total weighted flags is less than the weighted reject threshold, then an empty state may be determined. If both conditions of logic 104 are met, then routine 100 generates a dynamic ride empty state output at block 106. Thus, a minimum number of empty flags and fewer than weighted reject threshold weight flags are required by supervisory routine 100 to allow the system 12 to output an empty status. The dynamic ride algorithm logic 108 similarly sums up the total weighted flags of accelflag, decelflag and variflag and compares the sum total to a weighted_threshold. Additionally, logic 108 sums up the empty flags of accelflag, decelflag and variflag to see if the summed total is less than the empty_reject_threshold. According to one example, empty_threshold may be set to three, weighted_reject_threshold may be set to one, weighted_threshold may be set to three, and empty_reject_threshold may be set to one. Thus, a minimum number of weighted flags and fewer than empty_reject_threshold empty flags are required by supervisory routine 100 to allow the system 12 to output weighted states. If both conditions of step 108 are met, routine 100 generates a dynamic ride weighted state output at block 110.

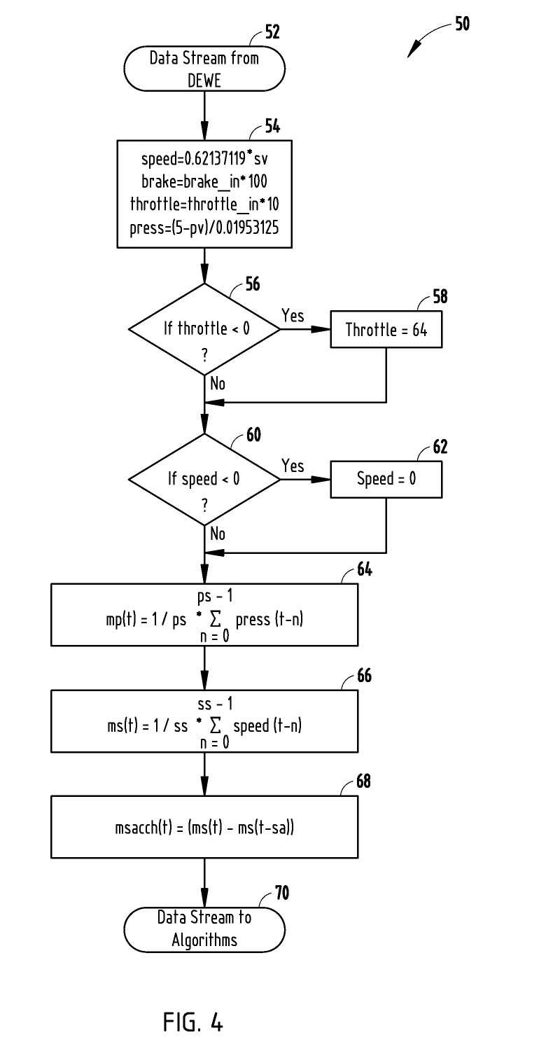

The passenger occupancy detection system 12 executes the various routines 100, 200, 300 and 400 to implement the occupancy detection method. In doing so, certain conditions are established as set forth in the algorithms setup routine 50 shown in FIG. 4. Routine 50 begins at step 52 to acquire the data stream from a data acquisition device, such as DEWE. A series of data points are collected from the vehicle electronic control unit (ECU) or the communication bus associated therewith. In block 54, signal smoothing is performed including speed and pressure smoothing. According to one embodiment, the multiplication factor is applied to the speed value (sv), brake is multiplied by a factor of one hundred, throttle is multiplied by a factor of ten and the pressure is established as a function of the pressure voltage. It should be appreciated that the data stream may be received at a periodic sampling rate, such as ten milliseconds, according to one embodiment.

Routine 50 proceeds to decision step 56 to see if the vehicle throttle is less than zero and, if so, sets the throttle equal to a value of sixty-four. Next, decision block 60 determines whether the vehicle speed is less than zero and, if so, sets the speed equal to zero in step 62. Proceeding to step 64, routine 50 determines the mean pressure as a function of time (mp(t)) to calculate a ps bar moving average of pressure to smooth the data where t is greater than or equal to pressure smoothing. Next, in step 66, routine 50 calculates a SS speed smoothing bar moving average of speed ms(t) to smooth the data where t is greater than or equal to SS. In step 68, routine 50 calculates a speed acceleration (sa) bar delta of speed to gather speed acceleration msacch(t). Finally, in step 70, routine 50 provides the processed stream of data to the various algorithms.

The variance routine 400, acceleration routine 200 and deceleration routine 300 each employ a model that may be trained to acquire coefficients for the respective models associated therewith. In doing so, a wide range of driving conditions may be implemented and used in the coefficient determination. In one embodiment, the same set of driving conditions may be employed to establish the coefficients for each model. A driving matrix or procedure may be established based on information gathered from a given course to establish a typical driving condition for the average vehicle user. Additionally, extreme conditions may be included to exploit both gentle and extreme driving conditions. Each driving condition may be examined with a predetermined weight, such as empty and five or ten pounds, applied to a given passenger seat. According to one example, the vehicle 10 may be driven a plurality of times with a minimum of two drivers over varying terrain including highway, country, city and gravel driving conditions. The driving may include riding the brake, super slow stop-coast down and super slow stop-very light brake conditions. A typical driving course or route may be driven for a minimum time period such as four hours, according to one example.

For the model training and coefficient acquisition process, the variance model for the variance routine may acquire coefficients which are calculated during the driving event. The driving conditions may export the range variable every one hundred seconds to an Excel spreadsheet with flags indicating driving condition and weight status. Two coefficients may be determined from prior data, Eₜ and Wₜ the empty and weighted threshold coefficients, respectively, where

Eₜ=the mean empty range+1 sigma, and

Wₜ=mean 5# weighted range,

wherein sigma is the standard deviation for the empty seat condition, and the 5# is the weight applied to the seat during establishment of the threshold.

One example of the variance calculation worksheet is provided in Table 1 below:

TABLE 1
Variance Calculation Worksheet

| occupant | range | mean | stdev | Eₜ | Wₜ |
|---|---|---|---|---|---|
| empty | 19.2 | | | | |
| empty | 18.5 | | | | |
| empty | 37.9 | | | | |
| empty | 41.0 | | | | |
| empty | 39.5 | | | | |
| empty | 46.1 | 33.7 | 11.84922 | 45.6 | |
| 5 pound | 87.8 | | | | |
| 5 pound | 80.0 | | | | |
| 5 pound | 76.3 | | | | |
| 5 pound | 181.2 | | | | |
| 5 pound | 240.2 | | | | |
| 5 pound | 246.4 | | | | |
| 5 pound | 129.7 | 148.8 | 74.17057 | | 148.8 |
| 10 pound | 70.0 | | | | |
| 10 pound | 61.8 | | | | |
| 10 pound | 170.2 | | | | |
| 10 pound | 223.3 | | | | |
| 10 pound | 112.9 | | | | |
| 10 pound | 111.4 | 124.9 | 61.7317 | | |

The driving conditions described above may be also used to calculate the acceleration model coefficients, accel_thres_e, and accel_thres_w. The coefficient accel_thresh_e represents the threshold for detecting an empty seat state and the coefficient accel_thres_w represents the threshold for detecting a weighted seat state for the acceleration algorithm. The lower accel_delta weight shifts represent empty conditions. An Excel spreadsheet may be generated to gather all accel_delta values during the vehicle training runs. Accel_delta represents the difference between minimum and maximum pressure during the acceleration event. This data set may be grouped by weight status and means and standard deviations calculated. The acceleration model routine includes the accel_delta calculation. The accel_thres_e and accel_thres_w equations are as follows:

accel_thres_e=mean empty accel_delta;

accel_thres_w=mean 5# weighted accel_delta+1 sigma.

One example of an acceleration calculation worksheet is provided in Table 2 below:

TABLE 2
Acceleration Calculation Worksheet

| occupant | acceldelta | Mean | stdev | accel_thres_e | accel-thres_w |
|---|---|---|---|---|---|
| empty | 2.0 | | | | |
| empty | 3.2 | | | | |
| empty | 3.5 | | | | |
| empty | 4.3 | | | | |
| empty | 4.9 | | | | |
| empty | 5.4 | | | | |
| empty | 4.6 | | | | |
| empty | 5.5 | 4.2 | 1.2 | 4.2 | |
| 5 pounds | .8 | | | | |
| 5 pounds | .3 | | | | |
| 5 pounds | .4 | | | | |
| 5 pounds | .1 | | | | |
| 5 pounds | .0 | | | | |
| 5 pounds | .8 | | | | |
| 5 pounds | .6 | | | | |
| 5 pounds | .7 | | | | |
| 5 pounds | .8 | | | | |
| 5 pounds | .5 | | | | |
| 5 pounds | .8 | 5.7 | 0.7 | | 6.5 |
| 10 pounds | 4.1 | | | | |
| 10 pounds | 3.3 | | | | |
| 10 pounds | 4.9 | | | | |
| 10 pounds | 5.5 | | | | |
| 10 pounds | 5.0 | | | | |
| 10 pounds | 5.5 | | | | |
| 10 pounds | 4.8 | | | | |
| 10 pounds | 5.2 | | | | |
| 10 pounds | 6.2 | | | | |
| 10 pounds | 5.3 | 5.0 | 0.8 | | |

The driving conditions described above may further be used to calculate the deceleration model coefficients decel_thres_e and decel_thres_w representing deceleration thresholds required for detecting empty and weighted seats, respectively. More negative values in the decel_delta variable representing weight shift during deceleration indicate weighted status. An Excel spreadsheet may be generated to include all decel_delta values gathered during the vehicle training runs. Decel_delta represents the difference between minimum and maximum pressure during the deceleration event. This data may be grouped by weight status and statistics of mean and standard deviation calculated. The deceleration model routine shows the decel_delta calculation. The equations for decel_thres_e and decel_thres_w according to one embodiment are provided as follows:

decel_thres_e=mean empty decel_delta;

decel_thres_w=mean 5# weighted decel_delta−1 sigma

One example of the deceleration calculation worksheet is provided in Table 3 below:

TABLE 3
Deceleration Calculation Worksheet

| occupant | deceldelta | mean | stdev | decel_thres_e | decel_thres_w |
|---|---|---|---|---|---|
| empty | −2.5 | | | | |
| empty | −2.8 | | | | |
| empty | −2.9 | | | | |
| empty | −2.7 | | | | |
| empty | −2.4 | | | | |
| empty | −2.2 | | | | |
| empty | −2.9 | | | | |
| empty | −2.7 | | | | |
| empty | −2.7 | −2.7 | 0.2 | −2.7 | |
| 5 pounds | −3.2 | | | | |
| 5 pounds | −3.0 | | | | |
| 5 pounds | −3.1 | | | | |
| 5 pounds | −2.9 | | | | |
| 5 pounds | −2.8 | | | | |
| 5 pounds | −3.2 | | | | |
| 5 pounds | −3.3 | | | | |
| 5 pounds | −3.0 | | | | |
| 5 pounds | −3.3 | | | | |
| 5 pounds | −3.6 | | | | |
| 5 pounds | −3.3 | | | | |
| 5 pounds | −3.3 | −3.1 | 0.2 | | −3.4 |
| 10 pounds | −5.6 | | | | |
| 10 pounds | −4.7 | | | | |
| 10 pounds | −5.0 | | | | |
| 10 pounds | −5.4 | | | | |
| 10 pounds | −4.2 | | | | |
| 10 pounds | −3.6 | | | | |
| 10 pounds | −4.3 | | | | |
| 10 pounds | −4.6 | | | | |
| 10 pounds | −4.3 | | | | |
| 10 pounds | −3.9 | | | | |
| 10 pounds | −3.6 | −4.5 | 0.7 | | |

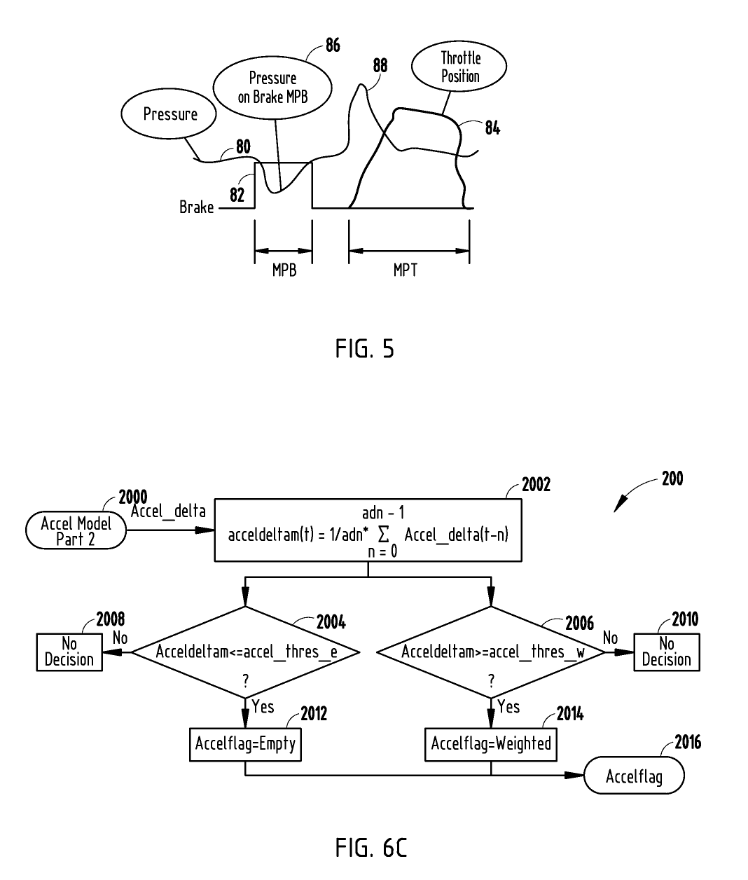

Referring now to FIG. 5, an exemplary graph illustrating a vehicle driving condition experienced initially with a vehicle brake action followed by a throttle induced acceleration of the vehicle is illustrated for use in describing the acceleration routine. The vehicle brake is applied as shown by line 82 during which the pressure sensed by the pressure sensor shown by line 80 decreases due to a shifting of the load of a passenger on a vehicle seat to establish a peak bottom pressure 86 responsive to the brake action. The decreased pressure is realized throughout the time period indicated by MPB (mean pressure braking) throughout the braking operation. A throttle operation is then experienced during time period MPT in which the throttle position indicated by line 84 is increased. The pressure sensed by the pressure sensor is shown increasing when the throttle position is initially applied to experience a peak pressure as shown by peak 88. The acceleration model routine monitors the driving condition to determine a braking event for calculating average pressure sensed on the vehicle seat. Next, an acceleration event is determined. The two segment averages are then compared. Relatively high differences from the comparison are usually associated with a weighted seat condition which is indicative of seat occupancy.

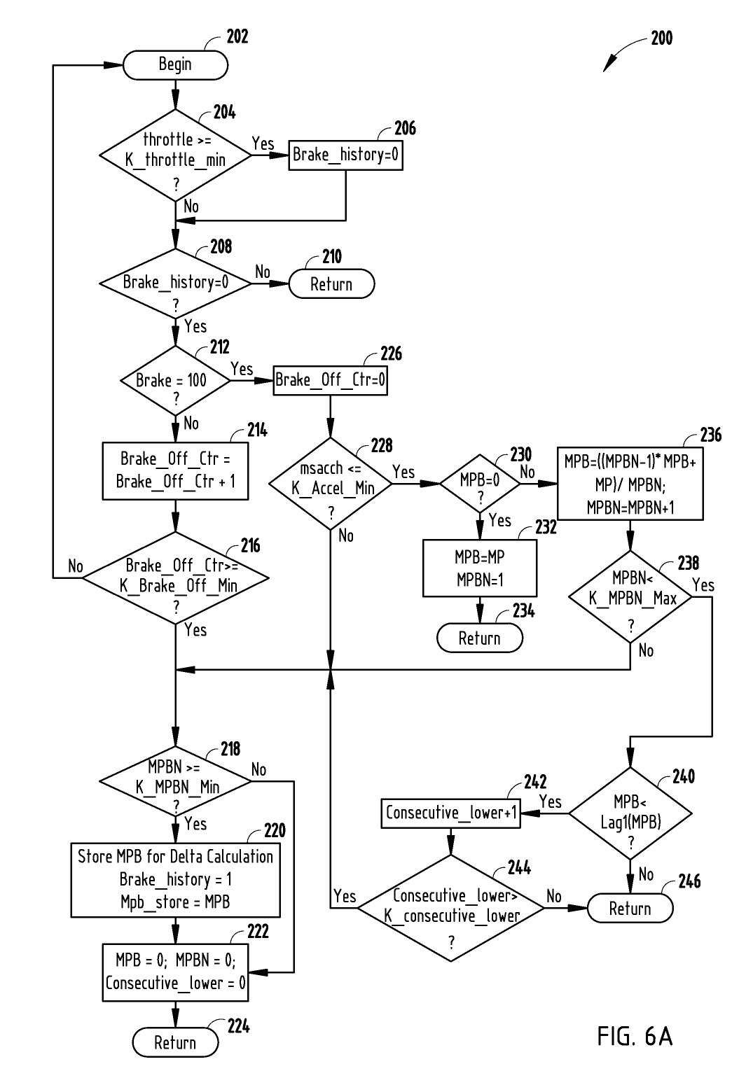

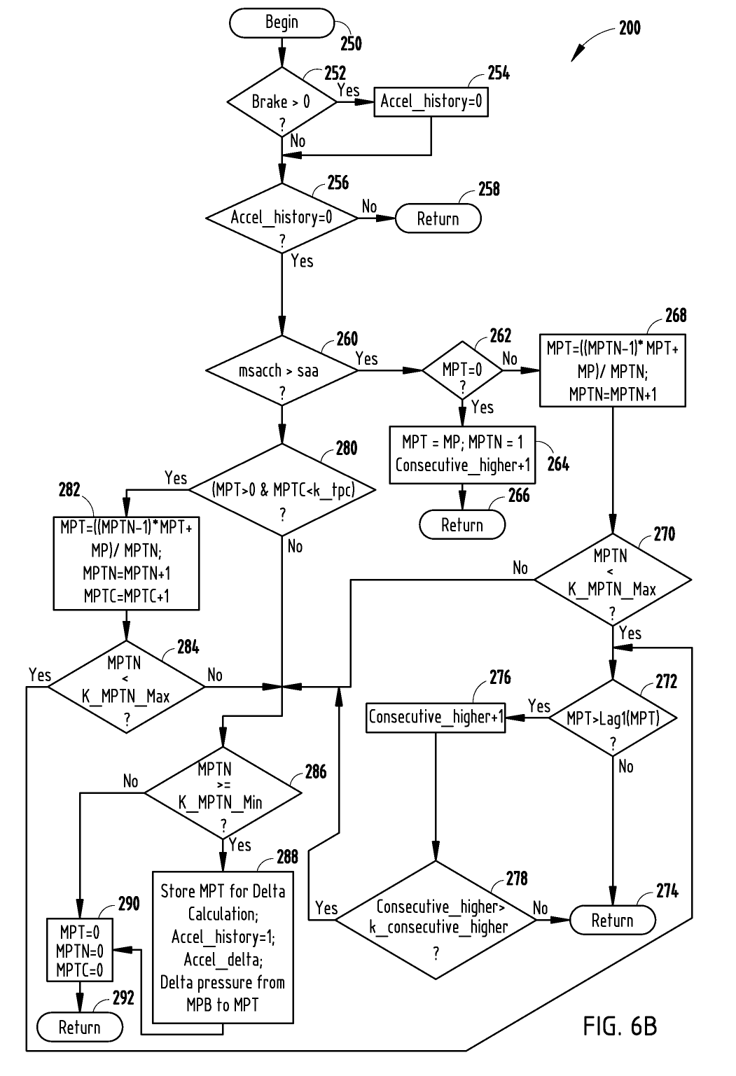

The acceleration model routine 200 is illustrated in FIGS. 6A-6C, which essentially includes three portions. The first portion of the acceleration routine 200 shown in FIG. 6A essentially monitors for a brake event at which time pressure data is accumulated until a peak pressure change is acquired. The routine 200 searches for events with sufficient deceleration to justify the data collection. Once gathered, the data is stored for the next stage which proceeds into the acceleration event. The second portion of the acceleration routine 200 shown in FIG. 6B looks for an acceleration event of sufficient energy to warrant the data collection. Once the acceleration event is detected, an increased pressure wave is captured as a mean of pressure during this time period. After completion of the acceleration data, a delta_accel is calculated which represents the span of pressure from the weightlessness of braking to the apparent increase in weight during an acceleration event. It is this delta_accel which is compared to an empirically derived threshold or thresholds which determines an empty or weighted state of the seat. The third portion of the acceleration routine 200 shown in FIG. 6C compares the acceleration values to thresholds to determine an empty or weighted seat condition and sets an acceleration flag to empty or weighted for use by the supervisory routine 100.

Referring now to FIGS. 6A-6C, the acceleration routine 200 is shown beginning at step 202 and proceeding to decision step 204 to determine whether the vehicle throttle is greater than or equal to K_Throttle_Min, wherein the K_Throttle_Min is the no throttle trigger point which may be set to zero. If the throttle is determined to be greater than the K_Throttle_Min, then routine 200 proceeds to step 206 to set the brake history to a value equal to zero, wherein the brake history requires the throttle to collect more data. In order to prevent multiple gathering events, after the first storage, routine 200 eliminates the possibility of additional triggers by setting the brake history equal to one.

The routine 200 proceeds to decision step 208 to determine whether the brake history equals zero and, if not, returns at step 210. If the brake history is set equal to zero, then routine 200 proceeds to determine if the brake is equal to one hundred and, increments the Brake_Off_Ctr by one in step 214, and then proceeds to decision step 216 to determine if the Brake_Off_Ctr is greater than or equal to the K_Brake_Off_Min and if not, returns to the beginning at step 202. If the Brake_Off_Ctr is greater than or equal to the K_Brake_Off_Min, then routine 200 proceeds to decision step 218 to determine if the MPBN is greater than or equal to K_MPBN_Min, wherein MPBN is the mean pressure braking sample counter having a value between zero and K_MPBN_Max. If MPBN is greater than or equal to K_MPBN_Min, then routine 200 proceeds to step 220 to store the MPB (mean pressure braking) for the delta calculation, sets the Brake_History equal to one, and sets the MPB_Store equal to MPB, and further proceeds to step 222 to set the MPB equal to zero, the MPBN equal to zero and the Consecutive_Lower equal to zero before returning at step 224. If the decision of block 218 is no, routine 200 proceeds directly to step 224. Thus, routine 200 detects the peak pressure drop as pressure is reduced during braking.

Referring back to decision step 212, if the brake is equal one hundred, then routine 200 proceeds to decision step 226 to set the Brake_Off_Ctr equals zero, and thereafter proceeds to decision step 228 to determine if the msacch (vehicle speed acceleration) is less than or equal to K_Accel_Min (minimum deceleration value) and, if not, proceeds to decision step 218. If msacch is less than or equal to K_Accel_Min, then routine 200 proceeds to decision step 230 to determine if the mean pressure braking (MPB) is set equal to zero and, if so, sets the mean pressure braking (MPB) equal to the mean pressure (MP) and sets the MPBN equal to one in step 232 before returning at step 234. If the MPB is not equal to zero at step 230, then routine 200 proceeds to step 236 to set the MPB equal to ((MPBN−1)*MPB+MP)/MPBN, and increments MPBN by one, and then proceeds to decision step 238 to determine if MPBN is less than K_MPBN_Max and, if not, proceeds to step 218. If MPBN is less than K_MPBN_Max, then routine 200 proceeds to decision step 240 to determine if MPB is less than a Lag1 (MPB) and, if not, returns at step 246. If MPB is less than Lag1 (MPB), then routine 200 proceeds to increment consecutive_lower by one and then proceeds to decision step 244 to determine if the consecutive_lower is greater than K_Consecutive_Lower, wherein K_Consecutive_Lower is the maximum number of samples to allow after peak, and may be less than one thousand. If the Consecutive_Lower is greater than K_Consecutive_Lower, then routine 200 proceeds to decision step 218. Otherwise, routine 200 returns at step 246.

The second portion of the acceleration routine is shown in FIG. 6B beginning at step 250 and proceeding to decision step 252 to determine if the brake is greater than zero, such that the brake is applied and, if so, proceeds to set step 254 to set the Accel_History equal to zero. Routine 200 proceeds to decision step 256 to determine if the accel_history is equal to zero, which requires the brake to collect more data and, if not, returns to step 258. If the Accel_History is set equal to zero, then routine 200 proceeds to determine whether the vehicle speed acceleration (msacch) is greater than the acceleration threshold saa at decision step 260 and, if so, proceeds to step 262. At step 262, routine 200 determines if the mean pressure during throttle (MPT) is set equal to zero and, if so, proceeds to step 264 to set the MPT equal to mean pressure (MP), to set the MPTN sample counter equal to one and to increment the Consecutive_Higher by one, which is the number of times the MPT is allowed to increase, before returning at step 266. This allows initial pressure gathering with high acceleration, then additional gathering at lower acceleration. If MPT is not equal to zero, then routine 200 proceeds to step 268 to gather pressure mean during acceleration by setting the MPT=((MPTN−1)*MPT+MP)/MPTN, and increments the MPTN by one. Thereafter, routine 200 proceeds to decision step 270 to determine if the MPTN is less than K_MPTN_Max, which is the maximum number of samples of post acceleration to take and, if not, proceeds to decision step 286. If MPTN is less than K_MPTN_Max, then routine 200 proceeds to decision 272 to determine if MPT is greater than Lag1 (MPT) and, if not, returns at step 274. If MPT is greater than Lag1 (MPT), routine 200 proceeds to step 276 to increment the Consecutive_Higher by one. If there is a low detect, then the routine 200 prevents the average from creeping up. Routine 200 then proceeds to decision step 278 to determine if the Consecutive_Higher is greater than K_Consecutive_Higher and, if not, returns to step 274. Otherwise, routine 200 proceeds to step 286.

Returning to decision step 260, if the vehicle speed acceleration msacch is not greater than the acceleration threshold saa, routine 200 proceeds to decision step 280 to determine if the mean pressure during throttle (MPT) is greater than zero, and if the MPT sample counter after acceleration (MPTC) is less than the number of data points of collection after acceleration is not met, (k_tpc), and, if so, proceeds to step 282 to set MPT=((MPTN−1)*MPT+MP)/MPTN, and to increment MPTN by one and to increment MPTC by one. Next, in decision step 284, routine 200 determines if the MPTN is less than K_MPTN_Max and, if so, proceeds to decision step 272. If MPTN is not less than K_MPTN_Max, or if the conditions of decision step 280 are not met, then routine 200 proceeds to decision step 286 to exit into the storage point which includes determining if MPTN is greater than or equal to K_MPTN_Min which is the minimum number of samples of post acceleration to take and, if so, proceeds to step 288 to store the MPT for delta calculation sets the Accel_History equal to one, store the accel_delta, and store the delta pressure from MPB to MPT and proceeds to step 290 to set MPT equal to zero, MPTN equal to zero, and MPTC equal to zero before returning at step 292.

The third portion of the acceleration routine 200 is illustrated in FIG. 6C receiving the parameters from the second portion of the acceleration model at step 2000 and proceeding to step 2002 with the acceleration_delta to determine the mean acceleration delta acceldeltam(t) as shown by the equation set forth in step 2002. The acceldeltam at any given point in time is then compared to both empty and weighted thresholds in steps 2004 and 2006. Specifically, in step 2004, routine 2000 determines if the acceldeltam is less than the empty acceleration threshold accel_thres_e and, if so, issues the accelflag indicative of an empty seat detected. If the acceldeltam is not less than or equal to the empty threshold accel_thres_e, no decision is made in step 2008. Similarly, the acceldeltam value is compared to the weighted acceleration threshold accel_thres_w in step 2006 and, if it exceeds the threshold, routine 200 proceeds to step 2014 to set the acceleration flag indicative of a weighted seat detected. Otherwise, no decision is made in step 2010. Accordingly, the acceleration flag is set as either empty or weighted, and an acceleration flag is issued at output 2016. The acceleration flag is indicative of whether or not the acceleration routine 200 has determined that a seat is empty or weighted, and the acceleration flag may be processed by the supervisory algorithm 100 as explained herein. It should be appreciated that the acceleration flag may be used independently of the supervisory algorithm and the other algorithms to indicate whether a seat has an occupant in it or not.

The deceleration model routine 300 examines conditions prior to a braking event and, then a braking event is monitored for an average peak pressure. The two mean averages prior to and during the braking event are then subtracted and then compared to thresholds for empty and weighted seat conditions to detect occupancy of the vehicle seat. The deceleration routine 300 essentially exploits the condition where an object in the vehicle seat is momentarily weightless or at a reduced weight in the seat during deceleration of the vehicle.

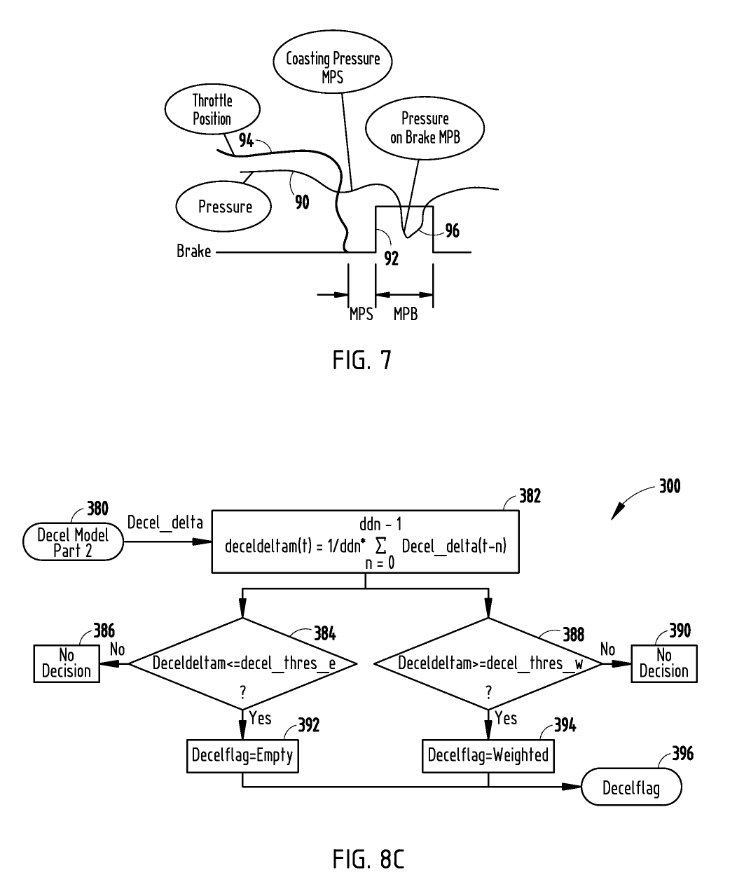

An example of a braking condition experiencing deceleration of the vehicle is illustrated in FIG. 7. As shown, the throttle position shown by line 94 decreases to no throttle, and a brake is subsequently applied at line 92 during which the sensed pressure 90 reaches a low pressure at point 96 during the brake MPB time period. Accordingly, the no throttle average pressure is gathered during the MPS time period and the braking average pressure is gathered during the MPB time period.

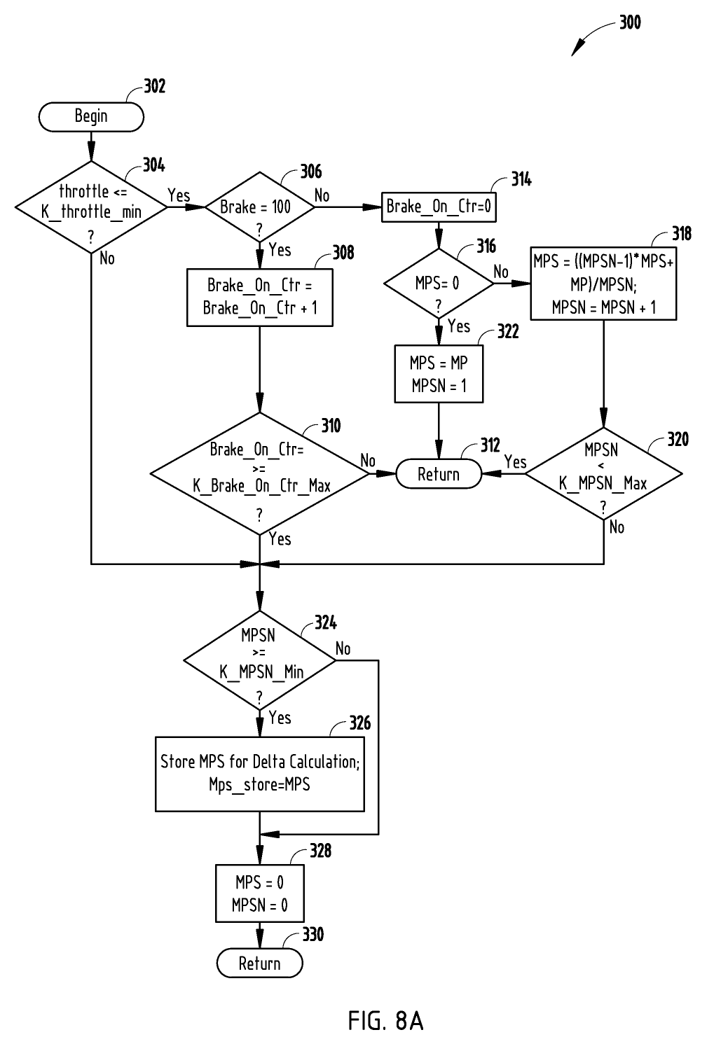

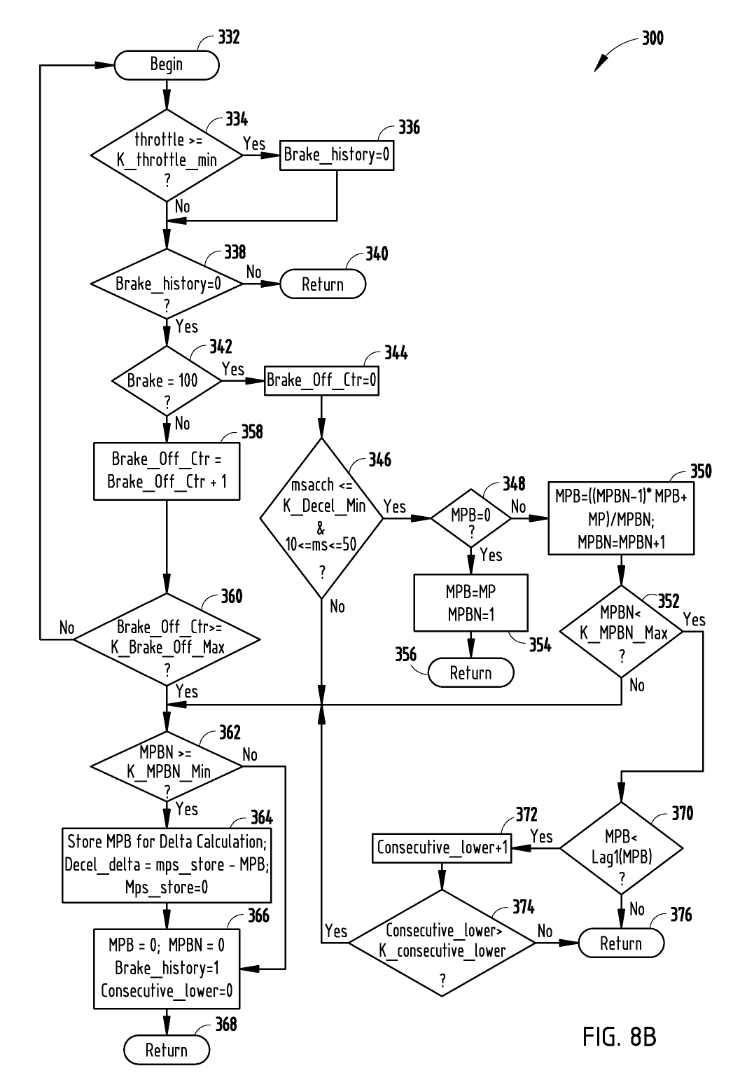

The deceleration routine 300 is shown and described herein in connection with three portions. The first portion shown in FIG. 8A monitors for a quiet condition during a no-throttle condition and then a decrease in weight during a braking event. In doing so, routine 300 continually examines the average pressure and stores the average pressure value once a brake event is detected, and the stored pressure value is used to calculate a range once the braking event is detected. The second portion of the deceleration routine 300 is shown in FIG. 8B and gathers a peak pressure value mean once a braking event is started using peak detection software that ensures that the highest values alone are captured. The third portion of the deceleration routine is shown in FIG. 8C which follows the second portion following completion of a braking event to calculate a delta pressure between the braking and pre-braking mean pressures. It is this change in pressure or delta pressure which is compared to an empirically derived threshold to determine an empty or weighted seat indicative of no occupancy or occupancy of the vehicle seat, respectively.

Referring back to FIG. 8A, the deceleration routine 300 begins at step 302 and proceeds to decision step 304 to determine whether the vehicle throttle is less than or equal to the no-throttle trigger point K_Throttle_Min and, if not, jumps ahead to step 324. If the throttle is less than or equal to the no-throttle trigger point K_Throttle_Min, then routine 300 proceeds to decision step 306 to determine whether the brake is equal to a value of 100 and, if so, increments the brake event counter Brake_On_Ctr by one in step 308, and then proceeds to decision step 310 to determine whether the brake event counter (Brake_On_Ctr) is greater than or equal to the maximum number of brake events before reset and store (K_Brake_On_Ctr_Max) and, if not, returns at step 312. If the maximum number of brake events is exceeded by the brake event counter, routine 300 proceeds to decision step 324.

If the brake is not set equal to one hundred at step 306, routine 300 proceeds to step 314 to set the brake event counter Brake_On_Ctr equal to zero. The routine 300 will only tolerate K_Brake_On_Ctr_Max braking events before being reset to the mean pressure stationary (MPS). Routine 300 then proceeds to decision step 316 to determine whether MPS is set equal to zero and, if so, which is indicative of the first time through the process, routine 300 sets the MPS equal to the mean pressure (MP) and further sets the MPS sample counter (MPS) equal to one in step 322 before returning at step 312. If the MPS is equal to zero at step 316, routine 300 proceeds to set the MPS=((MPSN−1)*MPS+MP)/MPSN, and increments MPSN by one in step 318. The mean pressure provides a mean average value while the vehicle continues to coast. Next, routine 300 proceeds to decision step 320 to determine whether the MPSN is less than the maximum number of samples of prebrake to take (K_MPSN_Max) and, if so, returns at step 312. Otherwise, routine 300 proceeds to decision step 324.

At decision step 324, routine 300 determines whether the MPSN is greater than or equal to the minimum number of samples of prebrake (K_MPSN_Min) and, if so, stores the MPSN for delta calculation and sets the MPS_Store equal to MPS in step 326. Next, or if decision block 324 is negative, routine 300 proceeds to set MPS equal to zero and MPSN equal to zero in step 328, before returning at step 330.

The second portion of the deceleration routine 300 is illustrated in FIG. 8B beginning at step 332 and proceeding to decision step 334 to determine if the vehicle throttle is greater than or equal to the no-throttle trigger point K_Throttle_Min and, if so, sets the brake history equal to zero. The brake history is indicative of required throttle to collect more data. The routine 300 does not allow multiple gathering events. After a first storage the possibility of additional triggers is prevented by setting the brake history equal to one. Next, at decision step 338, routine 300 determines whether the Brake_History which is the required throttle to collect more data is set equal to zero and, if not, returns at step 340. If the Brake_History is set equal to zero, routine 300 proceeds to decision 342 to determine if the brake is set equal to zero and, if so, sets the Brake_Off_Counter equal to zero at step 344. The Brake_Off_Ctr is the brake interrupt counter.

Following step 344, routine 300 proceeds to decision step 346 to determine whether the vehicle speed acceleration msacch is less than or equal to the minimum deceleration K_Decel_Min and to determine if the mean speed (ms) is within the range of ten to fifty. If either of the decisions in step 346 are not met, routine 300 advances ahead to step 362. If both conditions of decision step 346 are met, routine 300 proceeds to decision step 348 to determine whether the mean pressure braking MPB is set equal to zero and, if so, sets the MPB equal to the mean pressure MP and sets the MPB sample counter MPBN equal to one in step 354, before returning at step 356. If MPB is equal to zero in step 348, then routine 300 proceeds to step 350 to set the mean pressure braking MPB=((MPBN−1)*MPB+MP)/MPBN, and increments the MPBN by one. Thereafter, routine 300 proceeds to decision step 352 to determine if the MPBN is less than the maximum number of samples of post brake to take (K_MPBN_Max) and, if not, proceeds ahead to step 362. If the MPBN is less than K_MPBN_Max, then routine 300 proceeds to decision step 370 to determine whether the MPB is less than the Lag1 (MPB) and, if not, returns at step 372. If the MPB is less than Lag1 (MPB) then routine 300 proceeds to add one to the consecutive_lower which is the number of times the MPB is allowed to decrease, and then proceeds to decision step 374 to determine whether the consecutive_lower is greater than K_Consecutive_Lower, which is the maximum number of samples to allow after brake. If not, routine 300 proceeds to return at step 376. If Consecutive_Lower is greater than K_Consecutive_Lower, then routine 300 proceeds ahead to step 362.

Returning back to decision step 342, if the brake is not equal to one hundred, routine 300 proceeds to step 358 to increment the Brake_Off_Ctr by one, wherein the Brake_Off_Ctr is the brake interrupt counter. Next, routine 300 proceeds to decision step 360 to determine whether the Brake_Off_Ctr is greater than or equal to the K_Brake_Off Max and, if not, returns to step 332. Decision step 360 allows a maximum of K_Brake_Off Max events before a reset of the brake data is realized. If the Brake_Off_Ctr is greater than or equal to K_Brake_Off_Max, then routine 300 proceeds to decision step 362 to decide whether the MPBN is greater than or equal to K_MPB_Min and, if so, proceeds to step 364 to store the MPB for delta calculation, and to set the decel_delta equal to MPS minus MPB, and further sets the MPS_Store equal to zero. Next, in step 366, routine 300 sets the MPB equal to zero, sets the Brake_History equal to one, and sets the consecutive_lower equal to zero before returning at step 368.

The third portion of the deceleration routine 300 is illustrated in FIG. 8C, wherein the second portion of the deceleration model routine is provided at step 380 as a deceleration_delta applied to step 382 which determines the mean deceleration_delta deceldeltam(t) based on the equation shown, wherein ddn is the deceleration delta averaging variable. Next, routine 300 executes decision step 384 to determine if the decel_deltam is less than or equal to the decel empty threshold (decel_thres_e) and, if so, sets the decelflag equal to empty in step 392. Otherwise, no decision is made at step 386. Similarly, decision step 388 determines whether the decel_delta m is greater than or equal to the decel weighted threshold (decel_thres_w) and, if so, sets the decel flag equal to the weighted state at step 394. Otherwise, no decision is made at step 390. The routine 300 outputs a decelflag at step 396 which is indicative of either the empty or the weighted seat condition detected by the deceleration routine 300.

The variance routine 400 includes a variance model which looks at a number of samples of 250 milliseconds differences in pressure. These samples are graded by the highest and lowest five sampled pressures in order to calculate a range statistic. This statistic tends to be wider with increasing weights. The inertia of objects in the vehicle seat tends to accentuate pressure changes. Small ranges tend to be associated with empty states. Referring to FIG. 9, a graph illustrating various forces applied to the vehicle seat is shown. The concept of the variance routine 400 is to examine the distribution of pressure acceleration. The pressure acceleration is a measure of the range of change in the pressure sensor output. Lightweight objects tend to have less variation than heavier objects. A relatively small threshold Eₜ is given to indicate empty. A somewhat higher threshold Wₜ is applied to detect a weighted condition in the vehicle seat. According to one embodiment, the minimum amount of time required for this calculation is 100 seconds or 1,000 data points. However, it should be appreciated that other sampling times and execution times may be employed depending on the vehicle and driving conditions. As shown in FIG. 9, the various weights (e.g., five pounds, ten pounds, fifteen pounds) applied to a vehicle seat during a driving condition of the vehicle generate different sensed pressures as the vehicle is driven over various road terrain, typically with the higher the weight the higher the pressure sensed. The variance routine 400 processes the inertia of the weights applied to the seat as the vehicle is driven over various terrain to establish threshold values Eₜ and Wₜ and then monitors the pressure changes to the vehicle seat as the vehicle is driven to determine whether or not an occupant is detected in the vehicle seat.

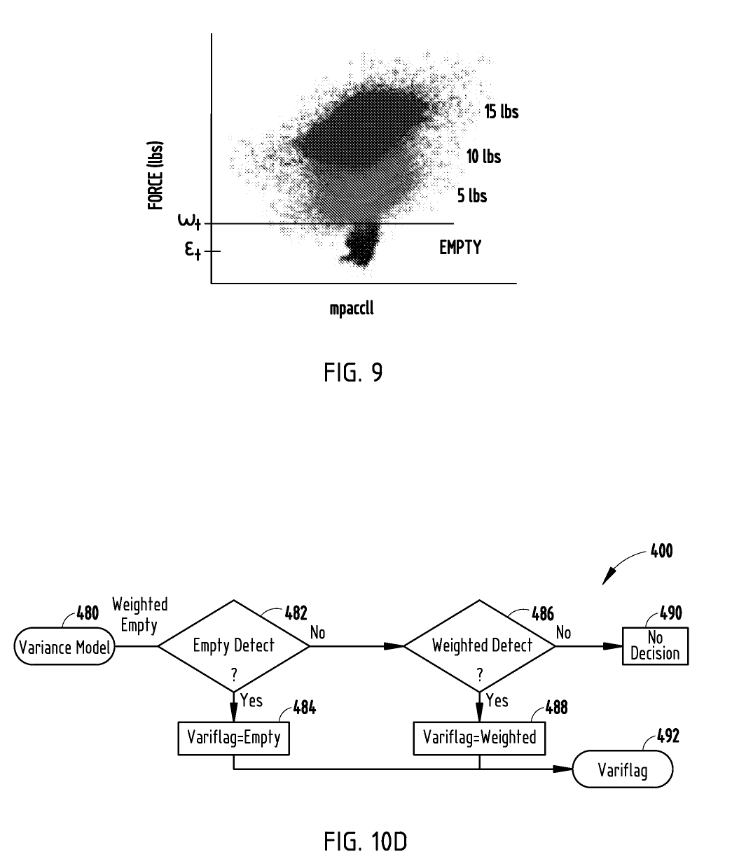

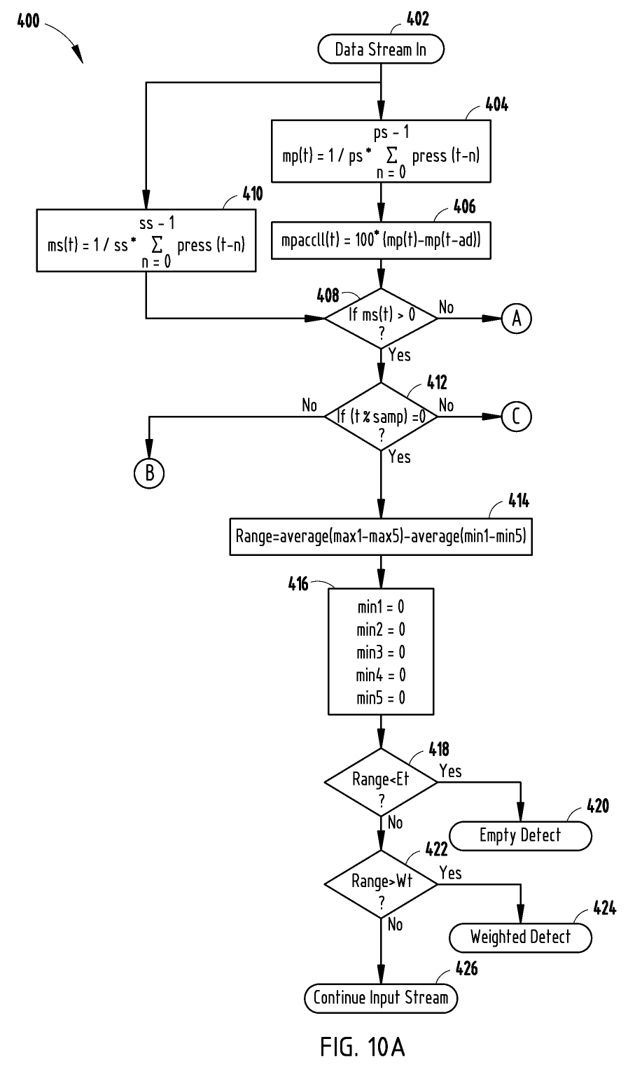

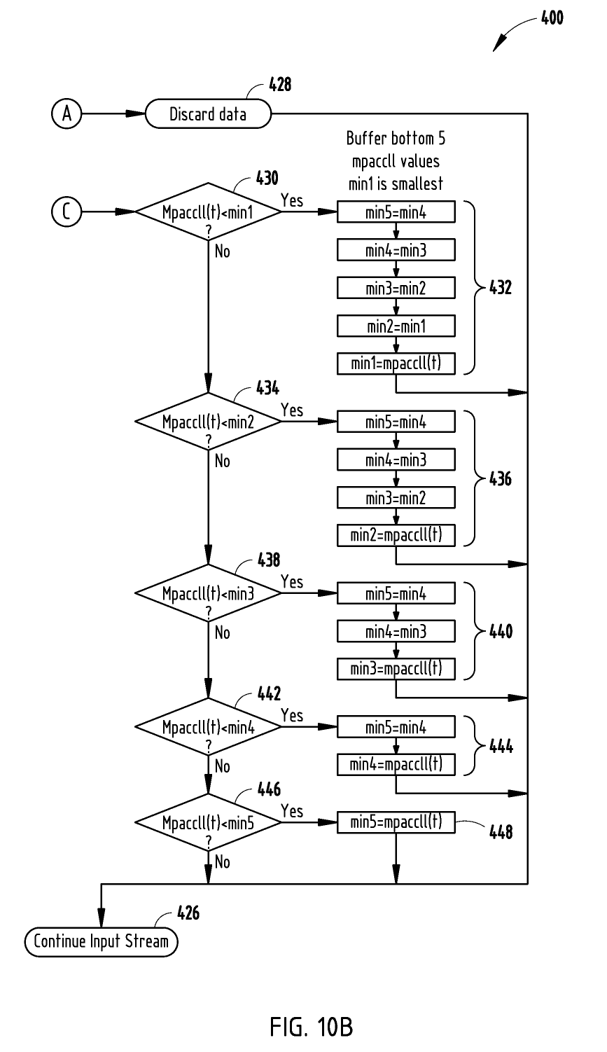

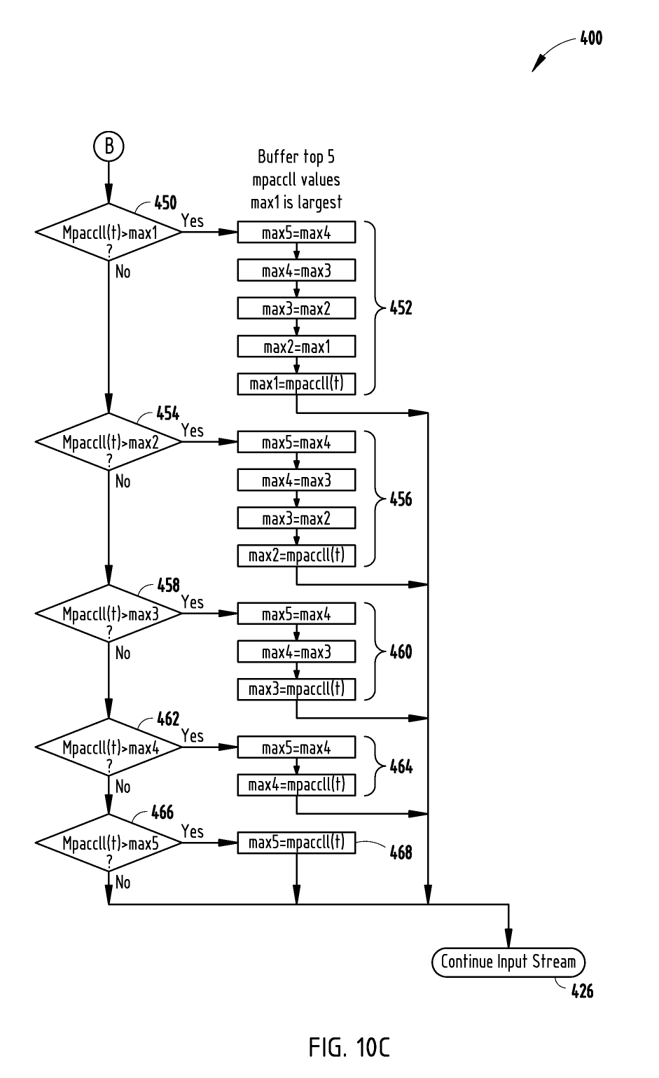

The variance routine 400 is illustrated in FIGS. 10A-10D. FIGS. 10A-10C illustrate a first portion of the variance algorithm 400 which monitors and saves maximum and minimum pressures and compares the values to the empty and weighted thresholds. FIG. 10D illustrates a second portion of the variance algorithm 400 which establishes the variflag output.

Referring to FIGS. 10A-10C, the variance routine 400 begins at step 402 to receive a data stream input which may be received with t equal zero initially and counting up every sample at a ten millisecond sampling rate, according to one embodiment. Next, at step 404, routine 400 calculates the mean pressure as a function of time as shown. This step includes calculating a pressure smoothing bar moving average of pressure to smooth the data where the time is greater than or equal to the pressure smoothing (ps). At the same time, routine 400 executes step 410 to calculate mean speed as a function of time (ms(t)) as shown. This step calculates a speed smoothing bar moving average of speed to smooth the data where time is greater than or equal to ss. Following step 404, routine 400 proceeds to calculate the pressure acceleration (mpaccll(t)) as a function of time as shown. This step includes calculating the variance calculation spread (ad) bar moving delta of pressure to get variance measurement where mp(t) exists. Following steps 406 and 410, routine 400 proceeds to decision step 408 to determine whether the mean speed ms(t) is greater than zero and, if not, discards the data at step 428 and then proceeds to continue the input stream at step 426. This effectively ensures that only moving information is gathered.

If the vehicle is moving as indicated by decision step 408, routine 400 proceeds to decision step 412 to determine whether the time percent sample t % samp) is equal to zero. This selects the epochs of time sample equal to ten thousand or one hundred seconds of collection time, for example. If t % samp is equal to zero, routine 400 proceeds to step 414 to set the range equal to the average of the (Max 1 through Max 5) minus the average of (Min 1 through Min 5). The maximum and minimum values are stored in buffers as explained herein based on samples that are taken as the vehicle is driven. If t % samp is not equal to zero, routine 400 simultaneously collects maximum and minimum pressure samples as shown beginning at step 450 and 430.

At step 430, routine 400 compares the pressure acceleration mpaccll(t) with the minimum stored pressure value Min 1 and if the current acceleration is less than Min 1, proceeds to store the pressure mpaccll(t) in the buffer at step 432. Similarly, the pressure acceleration value is compared to the Min 2, Min 3, Min 4, Min 5 values at steps 434, 438, 432 and 446 and, if the acceleration mpaccll(t) is less than the respective Min 2, Min 3, Min 4, Min 5 values, proceeds to the respective steps 436, 440, 444 or 448 to store the acceleration value mpacll(t) in the memory buffer. As a result, the buffer stores the bottom five mpacll(t) values with the Min 1 being the smallest value. Thereafter, step 400 proceeds to continue the input stream at step 426.

Referring to step 450, routine 400 compares the pressure acceleration value mpacll(t) with the maximum value Max 1 and, if the maximum value Max 1 is exceeded, stores the acceleration value mpacll(t) in the memory buffer as the new Max 1 value. Similarly, decision steps 454, 458, 462 and 466 compare the acceleration value mpacll(t) with respect to maximum values Max 2, Max 3, Max 4, Max 5 and, if the corresponding values are exceeded, stores the mpacll(t) value in the buffer in steps 456, 460, 464 and 468. Accordingly, the buffer stores the top five mpacll(t) values, wherein Max 1 is the largest acceleration value. Thereafter, routine 400 proceeds to continue the input stream at step 426.

Given the storage and updating of the five minimum acceleration values Min 1 through Min 5 and the top five maximum acceleration values Max 1 through Max 5, routine 400 proceeds to step 414 when the number of samples or sampling time for collecting samples is complete and determines a range as a function of an average of the maximum values Max 1 through Max 5 minus the average of the minimum values Min 1 through Min 5. The range computed essentially provides an indication as to the inertia of the seat and any object on the vehicle seat. In step 416, the minimum values Min 1 through Min 5 are set equal to zero so as to reset the range every so many sampling seconds. Next, in decision step 418, routine 400 compares the range to an empty seat threshold E and, if the range is less than the empty seat threshold Eₜ, then routine 400 outputs an empty detect signal at step 420 indicative of an empty state of the seat. The range is also compared to a weighted seat threshold Wₜ in decision step 422. If the range exceeds the weighted threshold Wₜ, routine 400 outputs a weighted detect signal at step 424 indicative of a weighted state of the seat caused by occupancy of the seat. The empty seat threshold Eₜ may be a threshold determined during calibration and may be based upon the type of vehicle, type of seat, load characteristics expected for the vehicle seat. The weighted threshold W may be likewise be determined during calibration and may be based upon the vehicle, the type of seat and the expected characteristics for seating passengers in the seat. If the range is between the empty threshold Eₜ and the weighted threshold Wₜ, routine 400 proceeds to step 426 to continue the input stream.

A second portion of the variance routine 400 is illustrated in FIG. 10D with the output of the variance model received at step 480. Either the weighted or empty seat condition is provided to decision step 480. In decision step 482, routine 400 determines whether or not the vehicle seat is detected as being empty and, if so, sets the variflag equal to the empty flag state in step 484. Routine 400 also checks to see whether the weighted seat condition is detected in decision step 486 and, if so, sets the variflag equal to the weighted seat condition in step 488. If neither an empty detect or weighted detect is determined, routine 400 makes no decision in step 490. The variflag set equal to empty or a weighted state is then output as the variflag in step 492. The variflag is indicative of detection of an occupant in the vehicle seat based upon the variance routine 400 and may be processed along with the acceleration and deceleration routine outputs to determine whether or not an occupant is detected in the vehicle seat.

Accordingly, it should be appreciated that the acceleration routine 200, deceleration routine 300 and variance routine 400 may each determine occupancy of a vehicle seat as described herein. It should be appreciated that each of the acceleration algorithm 200, the deceleration algorithm 300 and the variance algorithm 400 may be employed separately to determine vehicle seat occupancy or may be used in combination such as two or three algorithms combined as processed by the supervisory algorithm 100 to determine whether or not a vehicle seat has an occupant seated therein. It should further be appreciated that the various routines described herein may be used in combination with other routines according to various other embodiments without departing from the teachings of the present invention.

The passenger occupancy detection system 12 may execute the routines described herein each time the vehicle is operated, which may be initiated by an engine start, according to one embodiment. Alternately, the passenger occupancy detection system 12 may execute the routines whenever the vehicle stops or vehicle speed falls below a minimum speed value. Thus, a change in occupancy of the seat may be detected despite continual operation of the vehicle engine. According to other embodiments, the passenger occupancy detection system 12 may execute the routines periodically to ensure that the occupancy of the seat has not changed during a driving event.

Accordingly, the passenger occupancy detection system 12 provides for detection of an occupant in a vehicle seat in a cost-effective and easy to calibrate system, without requiring the use of an accelerometer. The passenger occupancy detection system 12 detects occupancy of the vehicle seat with each of the acceleration routine 200, deceleration routine 300 and variance routine 400, each of which provides an output that is indicative of occupancy of the vehicle seat. The supervisory routine 100 further refines the occupant detection by processing the outputs of each of the acceleration routine 200, deceleration routine 300, and variance routine 400 to provide a single output indicative of the detected occupancy of the vehicle seat.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A passenger occupancy detection system for detecting occupancy of a vehicle seat, said system comprising:
a pressure sensor operatively associated with a passenger seat in a vehicle for sensing pressure applied to the vehicle seat; and
a controller for determining occupancy of the seat, said controller comprising:
first logic for monitoring the sensed pressure and determining a change in pressure as the vehicle is driven, said first logic comparing the change in pressure to a first threshold to generate a first output;
second logic for monitoring the sensed pressure and determining a change in pressure during at least one of an acceleration of the vehicle and a deceleration of the vehicle, and generating a second output based on the sensed pressure during the at least one of the acceleration and deceleration of the vehicle; and
third logic for processing the first and second outputs to generate a third output indicative of occupancy of the seat.

2. The system as defined in claim 1, wherein the second logic comprises:
acceleration logic for detecting acceleration of the vehicle and determining pressure during the acceleration event, said acceleration logic comparing pressure before and during the acceleration event and generating the change in pressure based on the comparison and generating an acceleration output indicative of expected occupancy based on the change in pressure during acceleration; and
deceleration logic for sensing deceleration of the vehicle and determining a change in pressure during deceleration and without deceleration of the vehicle and generating a deceleration output indicative of expected occupancy based on the change of pressure during deceleration, wherein the third logic processes the acceleration output and the deceleration output in combination with the first output to generate the third output indicative of occupancy of the seat.

3. The system as defined in claim 1, wherein the first logic determines a change in pressure as a difference between a maximum sensed pressure and a minimum sensed pressure due to inertia as the vehicle is driven.

4. The system as defined in claim 1, wherein the third logic sums the first and second outputs of the first and second logic and generates the third output based on the summed total.

5. The system as defined in claim 1, wherein the first output comprises a first flag and the second output comprises a second flag.

6. A method for determining occupancy of a vehicle seat, said method comprising the steps of:
sensing pressure applied to a passenger seat in a vehicle;
monitoring the sensed pressure as the vehicle is driven;
determining a change in sensed pressure as the vehicle is driven;
comparing the change in pressure to a first threshold to generate a first output indicative of expected occupancy of the seat;
monitoring the sensed pressure during at least one of an acceleration of the vehicle and a deceleration of the vehicle;
determining a change in pressure during the at least one of the acceleration of the vehicle and the deceleration of the vehicle;
generating a second output based on the sensed pressure during the at least one of the acceleration and deceleration of the vehicle; and
processing the first and second outputs to generate a third output indicative of occupancy of the seat.

7. The method as defined in claim 6, wherein the method employs acceleration logic for detecting acceleration of the vehicle and determining pressure during the acceleration event, the acceleration logic comparing pressure before and during the acceleration event and generating a change in pressure based on the comparison and generating an acceleration output indicative of expected occupancy based on the change in pressure, and deceleration logic for sensing a deceleration of the vehicle and determining a change in pressure during the deceleration and without deceleration of the vehicle, and generating a deceleration output indicative of expected occupancy based on the change in pressure, wherein the acceleration output and deceleration output are processed in combination with the first output to generate the third output indicative of the occupancy of the seat.

8. The method as defined in claim 6, wherein the step of determining change in sensed pressure comprises determining a change in pressure as a difference between a maximum sensed pressure and a minimum sensed pressure due to inertia as the vehicle is driven.

9. The method as defined in claim 6, wherein the step of processing the first and second outputs comprises summing the first and second outputs and generating the third output based on the summed total.

10. The method as defined in claim 6, wherein the first output comprises a first flag and the second output comprises a second output comprises a second flag.

11. A passenger occupancy detection system for detecting occupancy of a vehicle seat, said system comprising:
a pressure sensor operatively associated with a passenger seat in a vehicle for detecting pressure on the seat;
vehicle dynamics inputs for determining at least one of acceleration and deceleration of the vehicle; and
a controller for detecting occupancy of the seat, said controller processing the vehicle dynamics inputs and determining at least one of acceleration and deceleration of the vehicle and measuring pressure during at least one of acceleration and deceleration of the vehicle and without the at least one of acceleration and deceleration of the vehicle and determining a change in pressure, said controller further determining occupancy of the seat based on the change in the sensed pressure.

12. The system as defined in claim 11, wherein the controller senses acceleration of the vehicle and determines a first pressure value, and the controller senses pressure without acceleration of the vehicle and determines a second pressure value and determines the difference in the pressure values and further compares the difference in pressure values to a threshold to determine occupancy of the vehicle.

13. The system as defined in claim 12, wherein the sensed pressure without acceleration comprises a sensed pressure during a deceleration of the vehicle during a vehicle braking event.

14. The system as defined in claim 11, wherein the controller determines deceleration of the vehicle and senses pressure during the deceleration and compares the sensed pressure during the deceleration to a sensed pressure without deceleration and compares the difference to a threshold to determine occupancy of the seat.

15. The system as defined in claim 11, wherein the change in pressure comprises a maximum pressure and a minimum pressure.

16. The system as defined in claim 11, wherein the threshold comprises an empty threshold indicative of an empty seat and a weighted threshold indicative of a weighted seat.

17. A method for determining occupancy of a vehicle seat, said method comprising the steps of:
sensing pressure applied to a passenger seat in a vehicle;
determining at least one of acceleration and deceleration of the vehicle;
measuring pressure during at least one of the acceleration and deceleration of the vehicle and without the at least one of acceleration and deceleration of the vehicle;
determining a change of pressure sensed during the at least one of acceleration and deceleration of the vehicle and pressure sensed without the at least one of acceleration and deceleration of the vehicle; and
determining occupancy of the seat based on the change in the sensed pressure.

18. The method as defined in claim 17, wherein the method senses acceleration of the vehicle and determines a first pressure value, and senses pressure without acceleration of the vehicle and determines a second pressure value, and determines the difference in the first and second values, and further compares the difference of first and second values to a threshold to determine occupancy of the vehicle.

19. The method as defined in claim 18, wherein the sensed pressure without acceleration comprises a sensed pressure during a deceleration of the vehicle during a vehicle braking event.

20. The method as defined in claim 17, wherein the method determines deceleration of the vehicle and senses pressure during the deceleration and compares the sensed pressure during the deceleration to a sensed pressure without deceleration and compares the difference to a threshold to determine occupancy of the seat.

21. A passenger occupancy detection system for detecting occupancy of a vehicle seat, said system comprising:
a pressure sensor operatively associated with a passenger seat in a vehicle for sensing pressure on the seat; and
a controller for sampling the sensed pressure during operation of the vehicle and detecting change in pressure values, said controller further determining a change in sensed pressure and comparing the change in pressure to a threshold to determine occupancy of the seat.

22. The system as defined in claim 21, wherein the controller determines the change in sensed pressure as a difference between maximum and minimum sensed pressures as the vehicle is driven.

23. The system as defined in claim 22, wherein the controller stores the maximum and minimum sensed pressures in a buffer.

24. The system as defined in claim 21, wherein the change in pressure is compared to an empty threshold indicative of an empty seat and is further compared to a weighted threshold indicative of a weighted seat.

25. The system as defined in claim 21, wherein a controller generates an output flag indicative of the sensed occupancy of the seat.

26. A method for determining occupancy of a vehicle seat, said method comprising the steps of:
sensing pressure on a passenger seat in a vehicle during operation of the vehicle;
sampling the sensed pressure during operation of the vehicle;
processing the sampled pressures based on amplitude;
detecting a change in pressure values as the vehicle is driven;
comparing the change in pressure values to a threshold; and
determining occupancy of the seat based on the change in pressure values compared to the threshold.

27. The method as defined in claim 26, wherein the method detects maximum and minimum pressure values and determines the change in pressure based on the maximum and minimum pressure values.

28. The method as defined in claim 27, wherein the method stores the maximum and minimum sensed pressure in a buffer.

29. The method as defined in claim 26, wherein the change in pressure is compared to an empty threshold indicative of an empty seat and is further compared to a weighted threshold indicative of a weighted seat.

30. The method as defined in claim 26, wherein the method generates an output flag indicative of the sensed occupancy of the seat.
